(19) United States
(12) Patent Application Publication
(10) Pub. No.: US 2026/0021977 A1
(43) Pub. Date: Jan. 22, 2026

(54) DEVICE AND METHOD FOR INDEPENDENTLY TRANSPORTING TWO GLASS PANES IN A PANE PROCESSING DEVICE

(71) Applicant: Glaston Germany GmbH, Neuhausen-Hamberg (DE)

(72) Inventors: Tobias Neff, Schömberg (DE); Uwe Risle, Neubulach (DE)

(73) Assignee: Glaston Germany GmbH, Neuhausen-Hamberg (DE)

(21) Appl. No.: 19/251,809

(22) Filed: Jun. 27, 2025

(30) Foreign Application Priority Data
Jul. 19, 2024 (DE) 102024120653.5

(51) Int. Cl. B65G 49/06; E06B 3/673

(52) U.S. Cl. CPC B65G 49/063; E06B 3/67365

(57) ABSTRACT

A transport device transporting upstanding glass panes in a pane processing device includes a first horizontal conveyor arranged in the lower region of a supporting wall. A second horizontal conveyor is arranged in line with the first horizontal conveyor. A suction conveyor contains a perforated suction belt, a section of which runs over a suction chamber. This section of the suction belt extends in the supporting plane parallel to the conveying direction from an area above the first conveying surface to an area above the second conveying surface. The transport device moves the second conveying surface synchronously with, or independently of, the first conveying surface. A spacer is arranged in the region above the second conveying surface and can be moved into a working position in which a guiding surface of the spacer is located on the side of the supporting plane opposite the suction chamber.

### CROSS-REFERENCE TO RELATED APPLICATIONS

This application claims priority to the German application number 10 2024 120 653.5 filed on Jul. 19, 2024, the entire content of which is fully incorporated herein with this reference.

### DESCRIPTION

### Field of the Invention

The invention is based on a transport device for transporting upstanding glass panes in a pane processing device. A first horizontal conveyor is arranged in the lower region of a supporting wall and forms an upward-facing first conveying surface. A second horizontal conveyor is arranged in line with the first horizontal conveyor and forms an upward-facing second conveying surface. A suction conveyor contains a perforated suction belt. A section of the suction belt runs over a suction chamber in order to suck a glass pane onto the suction belt. This section of the suction belt extends in the supporting plane parallel to the conveying direction from an area above the first conveying surface to an area above the second conveying surface.

### Background of the Invention

Such transport devices are known from a wide variety of applications in practice and have basically proved their worth when one glass pane after the other is transported into the glass pane processing device, processed and transported out again. The pane processing devices used in practice, for example devices for applying a spacer strand to a glass pane, are primarily adapted in size to a maximum size of glass panes that can still be processed on the device. If panes of smaller dimensions are also processed on such a device, this can lead to a considerable amount of time being required to transport a relatively small glass pane into and out of the device over relatively long distances.

It may be an object of the present invention to improve a device of the type mentioned above and to increase the quantity of glass panes that can be processed in a predetermined time. Another object of the invention may be to provide a corresponding method.

The object may be achieved by a transport device having the features of the independent device claim and by a method having the features of the independent method claim. Advantageous further embodiments are subject of dependent claims.

### SUMMARY OF THE INVENTION

The transport device according to the invention is configured for transporting upstanding glass panes in a glass pane processing device. The pane processing device contains a processing unit which can be moved up and down along a supporting plane formed by a supporting wall for the glass panes. A glass pane within the present invention can be meant to be a single glass sheet, an assembly composed of several glass sheets or an insulating glass pane. A pane processing device within the meaning of the present invention can be a device for applying a flexible spacer strand to a glass pane. The processing unit can be designed as an application head, which is guided along at least a section of the edge of the glass pane in order to apply the spacer strand. The processing unit can be used to apply a flexible spacer strand to an upstanding glass pane along its edge in a manner known per se. A spacer strand applied along the entire edge of the glass pane forms a spacer frame to keep two adjacent sheets panes at a distance in a finished insulating glass pane. The flexible spacer strand can be a pasty and thereafter solidifying spacer strand made of a thermoplastic material and/or a reactive cross-linking material, which strand is applied to the glass pane using a nozzle. The flexible spacer strand can also be unrolled from a supply roll as a ribbon-shaped material and applied to the glass pane. A pane processing device can also be a device known per se for sealing an edge joint of an insulating glass pane.

The transport device contains a first horizontal conveyor, a second horizontal conveyor and a suction conveyor. The first horizontal conveyor is arranged in the lower area of the supporting wall. The first horizontal conveyor forms an upward-facing first conveying surface. The first conveying surface can be moved linearly along a horizontal conveying direction to transport a glass pane standing on the conveying surface. The second horizontal conveyor is arranged in line with the first horizontal conveyor. It is therefore a single-track pane processing device. The second horizontal conveyor forms an upward-facing second conveying surface. The second conveying surface can also be moved linearly along the conveying direction.

Each conveying surface can be formed by a conveyor belt and/or a roller conveyor. Each conveying surface therefore forms an upwardly oriented contact surface for an upstanding glass pane, which can be supported by the supporting wall. Each conveying surface can carry an upstanding glass pane at its lower edge. The supporting wall forms a supporting plane extending parallel to the conveying direction. The supporting plane can be formed in a manner known per se, for example by an arrangement of a plurality of air nozzles and/or rollers. The supporting wall can have two spaced-apart parts, the distance between which provides a free space for the movement of the processing unit. The feature “upstanding” means that the supporting wall and the supporting plane formed by it are not exactly vertical or aligned with a plummet but are inclined backwards by a few degrees so that an upstanding glass pane leaning against the supporting wall does not tip forwards, i.e., away from the supporting wall. The supporting plane of the supporting wall can have an inclination of around 6° to 8° to the vertical.

The suction conveyor comprises a perforated suction belt. The suction belt contains several suction openings and is guided over a suction chamber subjected to pressure below ambient pressure. The section of the suction belt running over the suction chamber extends in the supporting plane and parallel to the conveying direction of the horizontal conveyors. A surface of the suction belt facing away from the suction chamber can be coplanar with the supporting plane. The suction chamber and thus also the suctioned section of the suction belt extend from an area above the first conveying surface to an area above the second conveying surface. A glass pane to be transported from the first horizontal conveyor to the second horizontal conveyor (and vice versa) can be aspirated by the suction conveyor at the same time. The transport device is designed and configured in such a way that the two conveying surfaces can be moved synchronously with each other, i.e., at the same speed along the conveying direction. The suction conveyor can assist the transportation of a glass pane from one horizontal conveyor to the other. In such a case, the first conveying surface, the second conveying surface and the suction conveyor are all moved at the same speed. In particular, the suction conveyor can prevent a relatively small glass pane from falling into a gap, which provides the space required between the two horizontal conveyors to lower the processing unit to an area below the conveying surface. In particular, a synchronized transport of the glass pane by the two horizontal conveyors and the suction conveyor can be carried out during application of a spacer strand along the lower or upper edge of a glass pane by the processing unit in a manner known per se. The first horizontal conveyor, the second horizontal conveyor as well as the suction conveyor can each contain a controllable drive. The transport device can comprise a central control device for controlling each drive at a predefined speed.

The transport device according to the invention is also configured to move the second conveying surface independently of the first conveying surface, in particular, according to the method according to the invention.

In the method according to the invention for independently transporting two glass panes in a glass pane processing device, a first glass pane stands at a slight angle on the first horizontal conveyor. The first glass pane is supported by the supporting wall and is sucked onto the suction conveyor. The first glass pane is transported linearly by the suction conveyor and the first horizontal conveyor together at a first speed along the horizontal conveying direction. A second glass pane stands at a slight angle on the second horizontal conveyor. The second glass pane is positioned at a distance from the suction conveyor by a spacer and is transported linearly by the second horizontal conveyor at a second speed along the conveying direction. The second speed is different from the first speed. One of the speeds can also be zero. One of the two glass panes can therefore stand still while the other glass pane is moved horizontally. The spacer can position the second glass pane at a distance from the suctioned section of the suction belt and, in particular, guide it in this position during its transportation. The spacer is arranged in the transport device so that it can be moved relative to the supporting wall. The spacer is assigned to the second conveying surface. The spacer is arranged in the region above the second conveying surface. The spacer can be moved into a working position in which a guiding surface of the spacer is located on the side of the suction belt opposite the suction chamber. The guiding surface is then located on the side of the supporting plane opposite the suction chamber.

The invention may have (but which are not necessary) significant advantages: (1) Using the invention, in particular, due to the spacer assigned to the suction conveyor, it is possible to transport two glass panes independently of each other in the pane processing device. (2) The spacer can prevent the second glass pane from also being sucked onto the suction belt. The second glass pane can therefore be moved at a different speed than the suction belt and the first glass pane. (3) It is possible to transport the second glass pane into the pane processing device on the second horizontal conveyor as soon as the first glass pane has left the second conveying surface. When the first glass pane has left the second conveying surface, it is still in the area of the processing unit. The first glass pane can be moved further by the suction conveyor and the first horizontal conveyor at the required speed in order to complete its processing. The first glass pane can also be stopped, for example to apply a spacer strand to its rear edge from bottom to top. (4) Overall time can be saved, as the second glass pane following the first glass pane can already be conveyed into the pane processing device and transported to just before the processing unit while the first glass pane is still being processed. This time saving can be relatively large, particularly in the case of a relatively large pane processing device in which the second horizontal conveyor has a relatively long length. (5) The invention makes it possible to reduce the cycle time for processing glass panes. This means that more glass panes can be processed in a given time. (6) A glass pane processing device or a production line in which the glass pane processing device is integrated are designed for a maximum size of glass panes to be processed therein. The invention allows to save particularly large amounts of time while glass panes are processed that are smaller than said maximum size.

In a further embodiment, the guiding surface of the spacer can be formed by at least one guiding roller and/or at least one air nozzle. The spacer can be arranged below or above the suction conveyor. The spacer can be moved back and forth transversely to the supporting plane, in particular, between a resting position and its working position. In its resting position, the spacer can be located on the same side of the supporting plane as the suction chamber. A supporting length of the spacer measured along the conveying direction can be greater than or equal to the length of a section of the suction belt that extends in the supporting plane above the second conveying surface.

In a further embodiment, a further spacer can be arranged in the area above the first conveying surface. The method according to the invention can thus be carried out in the opposite direction to the conveying direction. Once the processing of the first glass pane has been completed, it can be positioned at a distance from the suction conveyor by the spacer located above the first conveying surface, so that the subsequent second glass pane can be sucked onto the suction conveyor. Processing of the second glass pane by the processing unit can begin before the first glass pane has been transported out of the pane processing device by the first horizontal conveyor. This saves further time overall. The supporting length of the spacer can be greater than or equal to the length of a section of the suction belt that extends in the supporting plane above the conveying surface to which this spacer is assigned.

In a further embodiment of the method, the second glass pane can be moved back into the supporting plane by a back positioner. The back positioner can be a counter-push device, with the aid of which the second glass pane is pushed back against the suction conveyor. This can ensure that the second glass pane, at time when it is to be aspirated by the suction conveyor is in fact safely sucked onto the suction belt. The back positioner is a component of the transport device and can be moved relative to the supporting wall. A back positioner can be arranged both in the area above the first conveying surface and in the area above the second conveying surface. The spacer and/or the back positioner can each comprise a roller holder having with several freely rotatable guiding rollers. The outer circumferential surface of the guiding rollers then forms the guiding surface of the spacer or the back positioner. The guiding rollers of the roller holder can be arranged along a straight line that extends parallel to the supporting plane. All guiding rollers of one roller holder can have the same outer diameter. A roller holder can enable to easily and reliably change the position of the spacer and/or the back positioner.

### BRIEF DESCRIPTION OF THE DRAWINGS

Further details and advantages of the invention are explained with reference to embodiments of the invention and the attached drawings. Identical and corresponding components are provided therein with corresponding reference signs.

FIG. 1 shows a perspective view of a schematic glass pane processing device comprising a first embodiment of a transport device according to the invention.

FIG. 2 shows an enlarged view of a section of FIG. 1.

FIG. 3 shows an enlarged view of the transport device shown in FIG. 1.

FIG. 4 shows a schematic side view of the pane processing device of FIG. 1 wherein a spacer is in working position and a back positioner is in resting position.

FIG. 5 shows a view similar to FIG. 4 wherein the spacer is in resting position and the back positioner is in working position.

FIG. 6 shows a view similar to FIG. 4 wherein the spacer and back positioner are in resting position.

FIG. 7 shows a view similar to FIG. 2 of a second embodiment of a transport device according to the invention.

FIG. 8 shows a schematic side view of FIG. 7 wherein a spacer is in working position and a back positioner is in resting position.

FIG. 9 shows a view similar to FIG. 8 wherein the spacer is in resting position and the back positioner is in working position.

FIG. 10 shows a view similar to FIG. 8 wherein the spacer and the back positioner are in resting position.

### DETAILED DESCRIPTION OF EMBODIMENTS OF THE INVENTION

A pane processing device 1 contains a transport device 2, a processing unit 3 and a supporting wall 4. The supporting wall 4 contains two parts 4a and 4b, which are spaced apart from one another by a distance 4c. The supporting wall 4 forms a supporting plane 5 in a manner known per se, which is arranged slightly inclined to the vertical. The processing unit 3 contains a nozzle 6 for applying a spacer strand (not shown) to glass panes 7, 8 and can be moved up and down along a guiding rail 9 along the double arrow A for this purpose. The guiding rail 9 extends parallel to the supporting plane 5.

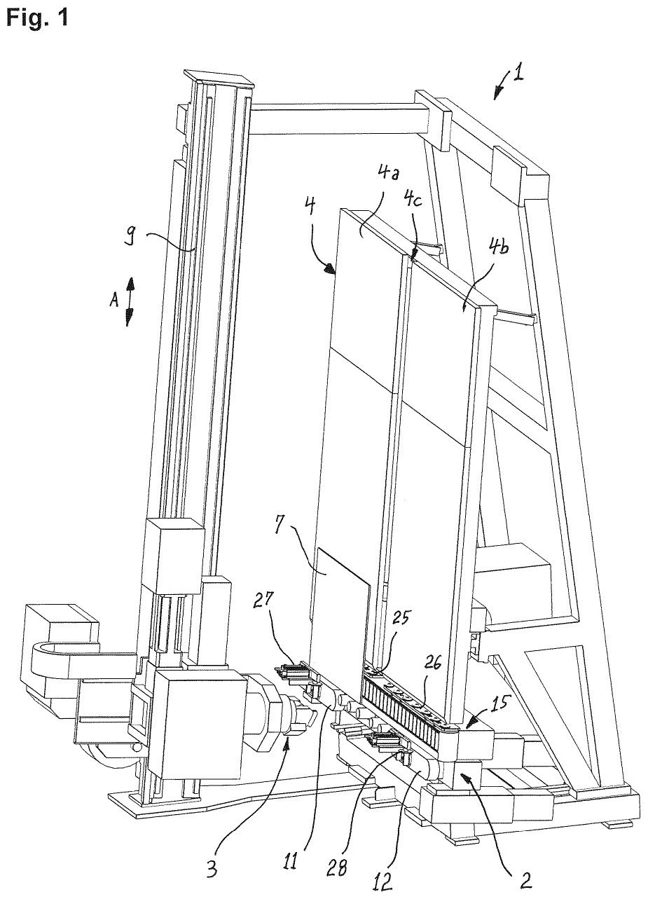

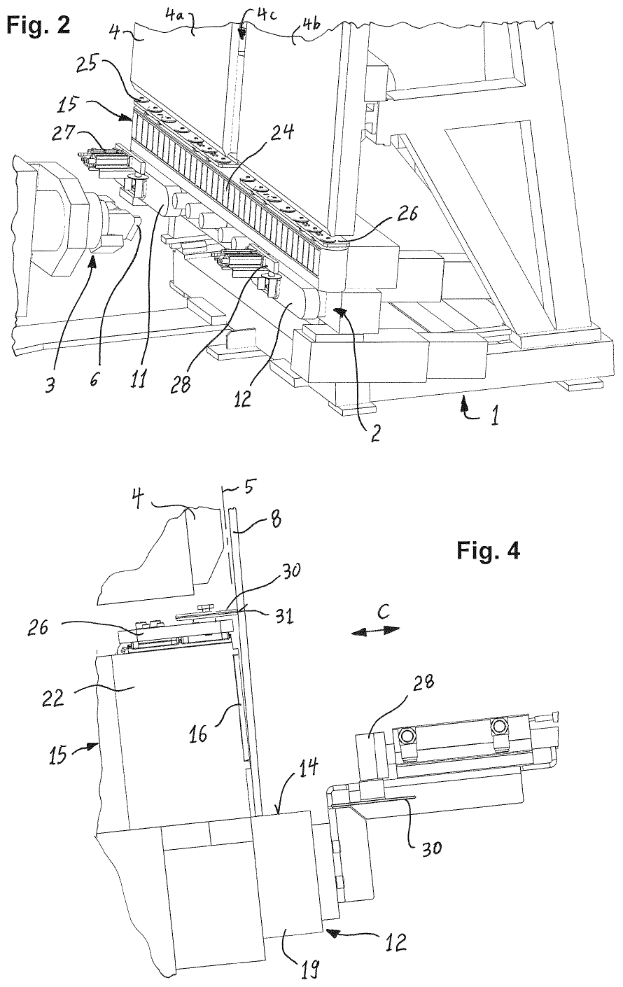

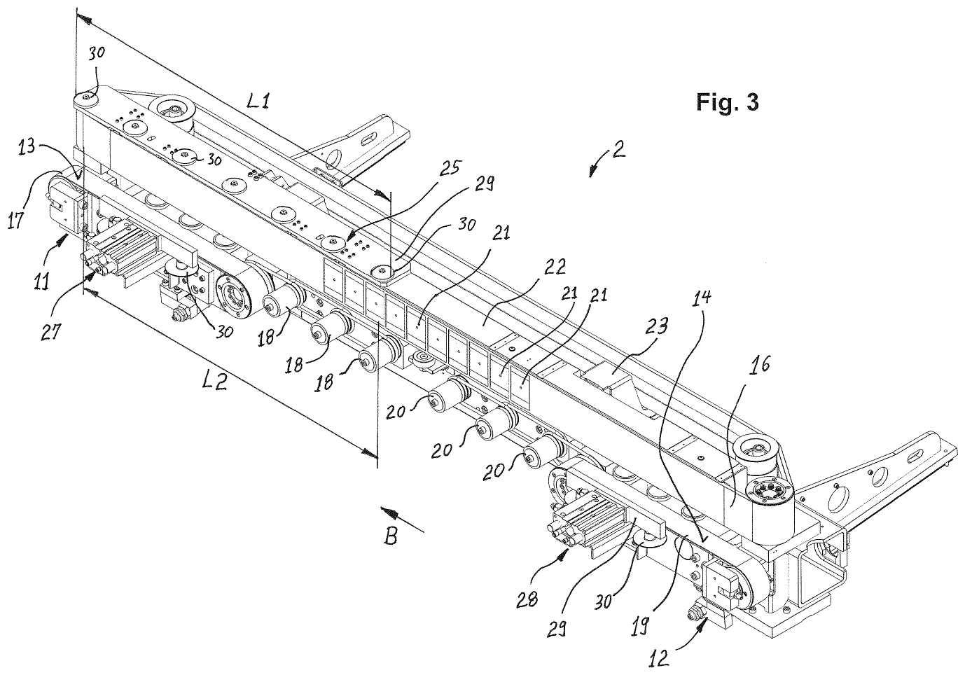

The transport device 2 contains a first horizontal conveyor 11 having a first conveying surface 13 and a second horizontal conveyor 12 having a second conveying surface 14 as well as a suction conveyor 15 having a suction belt 16, see, in particular, FIG. 3. The conveying surface 13 is formed by a conveyor belt 17 and three transport rollers 18 and can be moved by a drive not shown. The conveying surface 14 is formed by a conveyor belt 19 and three transport rollers 20 and can also be moved by a drive not shown. A first glass pane 7 stands slightly inclined on the first conveying surface 13 and is supported by the supporting wall 4, see FIG. 1. The glass pane 7 was transported into the pane processing device 1 by moving the conveying surfaces 13, 14 along a horizontal conveying direction B, see FIG. 1. The suction belt 16 contains a plurality of through-holes 21 and is guided endlessly over a suction chamber 22. Some of the through-holes 21 are shown in FIG. 3. The suction chamber 22 extends from an area above the first conveying surface 13 to an area above the second conveying surface 14. The suction belt 16 can be moved over the suction chamber 22 by a drive not shown. The suction chamber 22 is supplied with vacuum via a suction port 23. The section 24 of the suction belt 16 aspirated by the suction chamber 22 extends in the supporting plane 5 and parallel to the conveying direction B and can aspirate the glass pane 7 in a manner known per se.

To apply a spacer strand (not shown) to the glass pane 7, the nozzle 6 is guided along the edge of the glass pane 7. For application along the front and rear edge, the processing unit 3 is moved in direction A. For application along the upper and lower edge, the glass pane 7 is transported past the stationary processing unit 3 by the synchronously moving horizontal conveyors 11 and 12 and the suction conveyor 15 in conveying direction B or against the conveying direction B. Such an application of a spacer strand is known per se and therefore does not need to be described in more detail.

The transport device 2 comprises a first spacer 25, a second spacer 26, a first back positioner 27 and a second back positioner 28. The spacers 25, 26 and the back positioners 27, 28 are each designed as a roller holder 29 and each comprises several freely rotatable guiding rollers 30, see FIG. 3. The spacers 25, 26 and the back positioners 27, 28 can each be moved back and forth between a resting position and a working position along a direction of movement C oriented transversely to the supporting plane 5, see FIGS. 4 to 6. In this first embodiment, the spacers 25 and 26 are arranged above the suction conveyor 15. The supporting length L1 of the first spacer 25 measured along the conveying direction B is greater than the length L2 of a section of the suction belt 16 that extends in the supporting plane 5 above the conveying surface 13 to which this spacer 25 is assigned.

When the processing of the first glass pane 7 is almost complete and the glass pane 7 has left the conveying surface 14 in conveying direction B, it is sufficient to transport the glass pane 7 only by the conveying surface 13 and the suction belt 16 to complete the processing. The second horizontal conveyor 12 is also no longer required to transport the finished glass pane 7 out of the pane processing device 1 in conveying direction B. Consequently, the second conveyor surface 14 no longer needs to be moved synchronously with the conveyor surface 13 and the suction belt 16. Instead, the conveying surface 14 is moved independently after the first glass pane 7 has left the conveying surface 14. Before the processing of the first glass pane 7 has been completed, a second glass pane 8 can thus be transported into the pane processing device 1, see FIG. 4. For this purpose, the spacer 26 is moved into its working position as shown in FIG. 4, in which the guiding surface 31 of the spacer 26 formed by the circumferential surfaces of the guiding rollers 30 is located on the side opposite the vacuum chamber 22 with regard to the suction belt 16 or the supporting plane 5. A section of the supporting plane 5 is formed by the surface of the suction belt 16. The glass pane 8 standing on the conveying surface 14 is thus guided at a distance to the suction belt 16 during transportation by the horizontal conveyor 12. As a result, the glass pane 8 is not sucked onto the suction belt 16 and can be transported at a different speed than the suction belt 16.

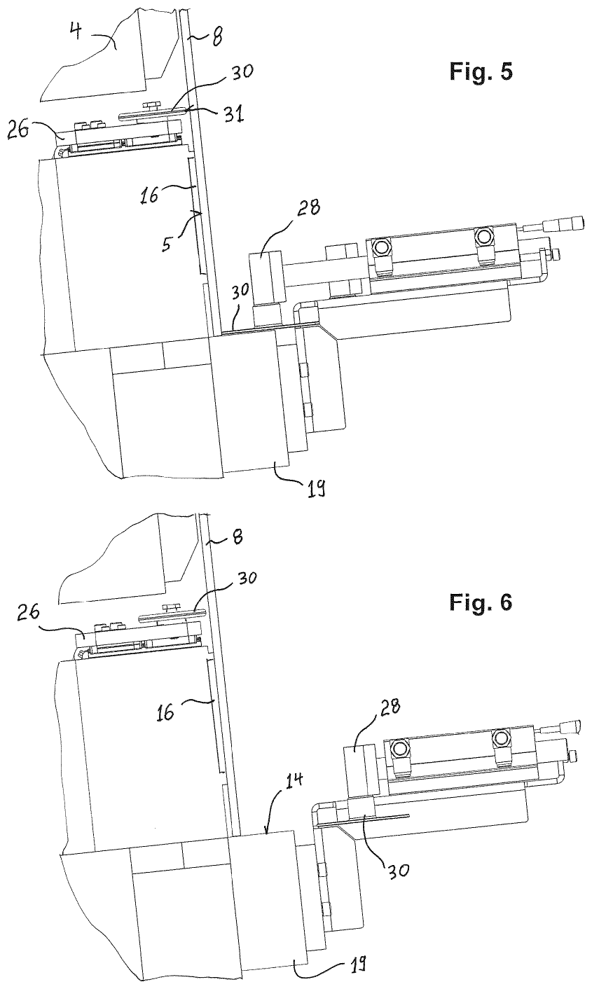

When processing of the first glass pane 7 is complete, the glass pane 7 can be transported out of the pane processing device 1 by the first horizontal conveyor 11 alone. The vacuum in the suction chamber 22 is switched off and the spacer 25 is moved into its working position so that the glass pane 7 is no longer sucked onto the suction belt 16. The vacuum in the suction chamber 22 is then switched back on. Now the spacer 26 is moved back into its resting position, see FIG. 5. At the same time, the back positioner 28 is advanced into its working position, see FIG. 5, to ensure that the second glass pane 8 moves back into the supporting plane 5 and is safely sucked onto the suction belt 16. The second pane 8 can now be transported by the horizontal conveyor 12 and the suction conveyor 15 so that the processing of the glass pane 8 by the processing unit 3 can begin. The spacer 26 and back positioner 28 can each be in their resting position, see FIG. 6. When the first glass pane 7 has been completely transported out of the glass pane processing device 1 and has left the conveying surface 13, the conveying surface 13 is moved again synchronously with the conveying surface 14 and the suction belt 16 in order to take over the second glass pane 8 coming from the second horizontal conveyor 12.

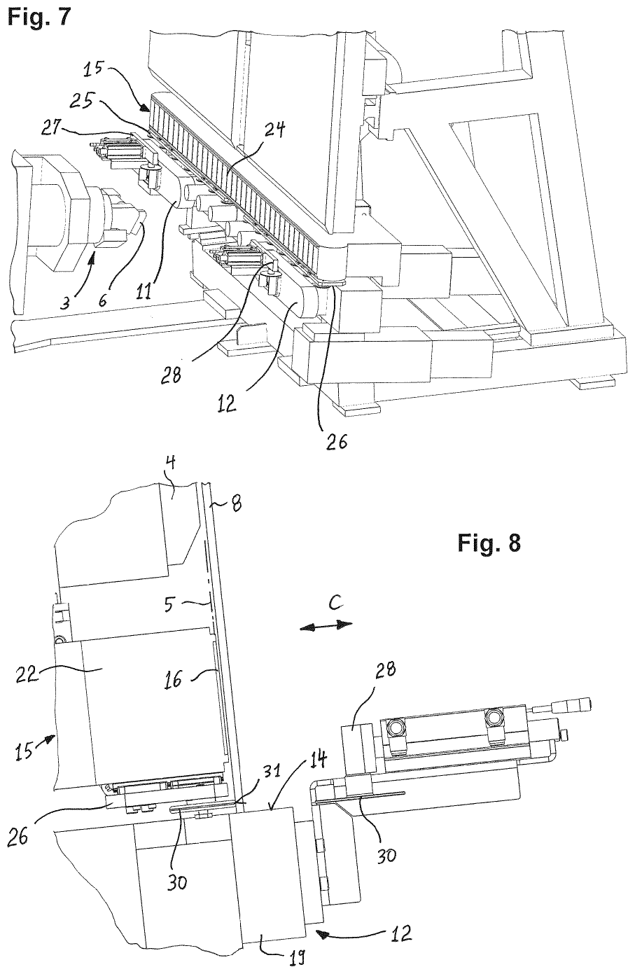

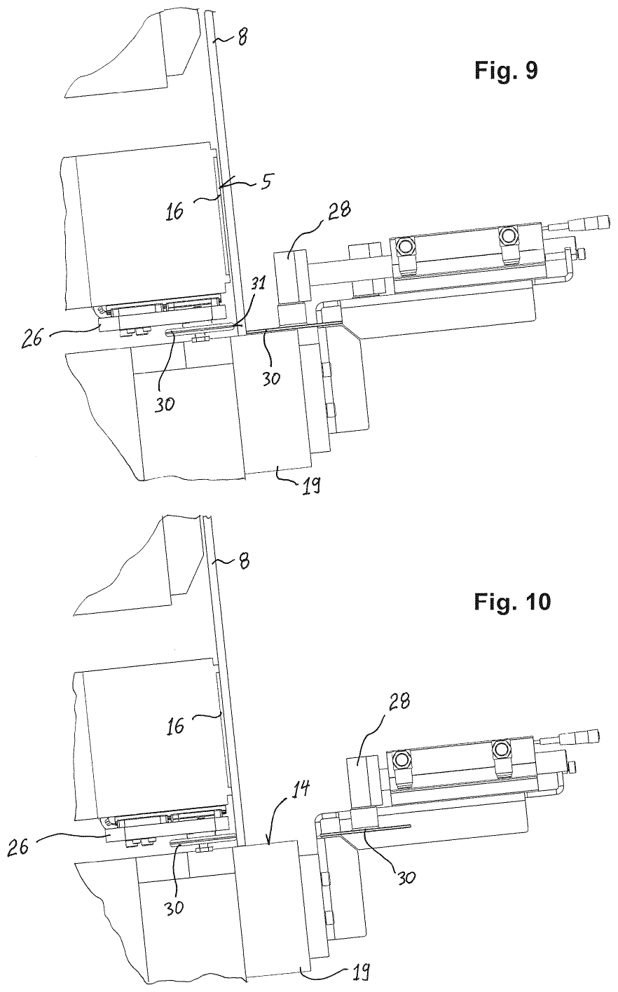

In a second embodiment as shown in FIGS. 7 to 10, the spacers 25 and 26 are arranged below the suction conveyor 15. Otherwise, the pane processing device 1 of the second embodiment is designed in the same way as in the first embodiment, so that reference is made to the above description in order to avoid repetition. The spacer 26 in its working position as shown in FIG. 8 guides the glass pane 8 at a distance from the suction belt 16, so that the glass pane 8 is not aspirated by the suction conveyor 15 and can be transported by means of the conveyor surface 14 independently of the speed of the suction belt 16. When processing of the first glass pane 7 is complete and the spacer 25 is in its working position, the spacer 26 is moved back to its resting position, see FIG. 9. At the same time, the back positioner 28 is moved into its working position, see FIG. 9. After the back positioner 28 has returned the glass pane 8 into the supporting plane 5 so that it rests against the suction belt 16, the back positioner 28 is moved back into its resting position, see FIG. 10. Otherwise, the procedure is the same as in the first embodiment, so that reference is made to the description above to avoid repetition.

### LIST OF REFERENCE SYMBOLS

1 Pane processing device
2 Transport device
3 Processing unit
4 Supporting wall
4a Part of the supporting wall
4b Part of the supporting wall
4c Distance
5 Supporting plane
6 Nozzle
7 First glass pane
8 Second glass pane
9 Guiding rails
11 First horizontal conveyor
12 Second horizontal conveyor
13 First conveying surface
14 Second conveying surface
15 Suction conveyor
16 Suction belt
17 Conveyor belt
18 Transport rollers
19 Conveyor belt
20 Transport rollers
21 Through holes
22 Suction chamber
23 Suction port
24 Aspirated section
25 First spacer
26 Second spacer
27 First back positioner
28 Second back positioner
29 Roller holder
30 Guiding rollers
31 Guiding surface
A Direction of movement
B Conveying direction
C Direction of movement
L1 Supporting length of spacer
L2 Length of suction belt section

What is claimed is:

1. A transport device configured for transporting upstanding glass panes, comprising:
a pane processing device with a processing unit which can be moved up and down along a supporting plane formed by a supporting wall;
a first horizontal conveyor arranged in a lower region of the supporting wall and forms an upward-facing first conveying surface, which is linearly movable along a horizontal conveying direction for transporting a glass pane standing on the first conveying surface;
a second horizontal conveyor arranged in line with the first horizontal conveyor and forms an upward-facing second conveying surface, which can be moved linearly along the conveying direction;
a suction conveyor comprising a perforated suction belt;
wherein a section of the suction belt runs over a suction chamber configured to be able to suck a glass pane onto the suction belt;
wherein said section of the suction belt extends in the supporting plane parallel to the conveying direction from an area above the first conveying surface to an area above the second conveying surface;
wherein the transport device is configured to move the second conveying surface synchronously with the first conveying surface or independently of the first conveying surface; and
wherein a spacer movable relative to the supporting wall is arranged in the region above the second conveying surface, which spacer can be moved into a working position in which a guiding surface of the spacer is located on the side of the suction belt opposite the suction chamber.

2. The transport device according to claim 1, wherein a further spacer is arranged in the region above the first conveying surface.

3. The transport device according to claim 1, wherein a supporting length, measured along the conveying direction, of the spacer is greater than or equal to the length of a section of the suction belt which is located in the supporting plane above that conveying surface to which this spacer is assigned.

4. The transport device according to claim 1, wherein the spacer comprises a roller holder having several freely rotatably arranged guiding rollers.

5. The transport device according to claim 1, comprising a back positioner movable relative to the supporting wall.

6. The transport device according to claim 1, wherein a back positioner is arranged both in the region above the first conveying surface and in the region above the second conveying surface.

7. The transport device according to claim 5, wherein the back positioner comprises a roller holder having several freely rotatably arranged guiding rollers.

8. The transport device according to claim 4, wherein the guiding rollers of the roller holder are arranged along a straight line which extends parallel to the supporting plane.

9. The transport device according to claim 4, wherein the roller holder is displaceable transversely to the supporting plane.

10. The transport device according to claim 5, wherein the back positioner, being its guiding rollers, is arranged at a height between the suction conveyor and the conveying surface of the respective horizontal conveyor.

11. A method for independently transporting two glass panes in a pane processing device, the method comprising the steps of:
standing a first glass pane slightly inclined on a first horizontal conveyor;
standing a second glass pane slightly inclined on a second horizontal conveyor;
supporting the first glass pane by a supporting wall and sucking it onto a suction conveyor, which extends in an area above the first horizontal conveyor and in an area above the second horizontal conveyor;
transporting the first glass pane linearly by the suction conveyor and the first horizontal conveyor together at a first speed along a horizontal conveying direction; and
positioning the second glass pane by a spacer at a distance to the suction conveyor and transporting it linearly by the second horizontal conveyor at a second speed along the conveying direction.

12. The method according to claim 11, wherein the spacer is moved away from the second glass pane, and wherein the second glass pane is subsequently moved back into the supporting plane, onto the suction conveyor, by a back positioner.
